(19) United States
(12) Patent Application Publication
(10) Pub. No.: US 2013/0341565 A1
(43) Pub. Date: Dec. 26, 2013

(54) LIQUID CRYSTAL MOLECULE HAVING FLEXIBLE STRUCTURE AND MIXTURE FOR THE SAME

(71) Applicant: Chung-Ching Hsieh, Shenzhen (CN)

(72) Inventor: Chung-Ching Hsieh, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/642,507

(22) PCT Filed: May 28, 2012
(86) PCT No.: PCT/CN2012/076142

§ 371 Date: Oct. 19, 2012

(30) Foreign Application Priority Data
May 18, 2012 (CN) 201210155273.4

(51) Int. Cl. C09K 19/30

(52) U.S. Cl. CPC C09K 19/3028; C09K 19/3003
USPC 252/299.63; 568/645; 568/643

(57) ABSTRACT

The present invention discloses a liquid crystal (LC) molecule having a flexible structure and a mixture thereof. A traditional LC molecule is modified into the LC molecule having the flexible structure. The wetting ability of the LC molecule within a color-filter-on-array (COA) type LC panel is increased by properties of the flexible structure, so that the LC molecule having the flexible structure can obtain better diffusing performance than that of the traditional LC molecule. The present invention can increase the wetting ability of the LC molecule within an LC panel by modification of the flexible structure of the LC molecule, and thus the problem of drop Mura effect in the COA type LC panel can be improved.

### BACKGROUND OF THE INVENTION

1. Field of the Invention

The present invention relates to a liquid crystal layer for a liquid crystal panel, and more specifically to liquid crystal molecule having a flexible structure and a mixture that can improve drop Mura effect.

2. Description of the Prior Art

A color-filter-on-array (COA) type liquid crystal display (LCD) is an LCD having a color filter and thin film transistor arrays disposed on the same substrate. In addition to an aperture ratio being effectively improved, the COA type LCD further can solve an alignment problem which occurs in a large-sized panel, as well as decreases current leakage being generated from a light exposure; and thus COA technology is applicable to a display of the large-sized panel.

However, since a black matrix (BM) or photo spacers (PS) are highly complicated in structural designs in a COA type liquid crystal (LC) substrate, a large mismatch exists between structural surfaces of the COA type LC substrate, and therefore causes LC materials to be mis-diffused and leads to a drop Mura effect in a screen of the COA type LCD. An LC layer generally comprises LC materials formed by rod-like LC molecules having a formula (VIII) or (IX) as follows:

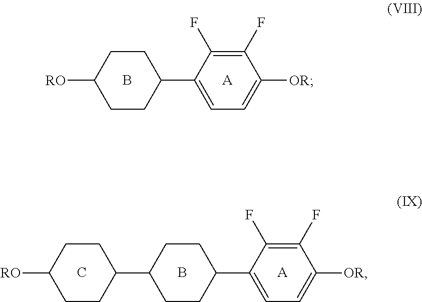

and in the formulas (VIII) and (IX), A represents benzene of an aromatic ring; B and C are cyclohexane of an alicyclic ring; RO— represents a terminal group, and RO— is an alkoxy group; F represents a lateral group, and F here is a fluorine atom.

Therefore, there is a need to provide the LC molecule which can improve the problem of drop Mura effect, so as to overcome the disadvantage in the prior art.

### SUMMARY OF THE INVENTION

In view of the above-mentioned, the present invention provides an LC molecule having a flexible structure and a mixture thereof, in order to solve the problem of drop Mura effect in the prior art.

An object of the present invention is to provide an LC molecule which can improve drop Mura effect. A traditional LC molecule is modified into the LC molecule having a flexible structure to obtain the LC molecule which can improve drop Mura effect. The flexible structure of the LC molecule includes a flexible chain and a flexible lateral group. The wetting ability of the LC molecule within a color-filter-on-array (COA) type LC panel is increased by properties of the flexible structure, so that the LC molecule having the flexible structure can obtain better diffusing performance than that of the traditional LC molecule. The present invention is capable of improving the problem of drop Mura effect in the COA type LC panel.

To achieve the above object, the present invention provides an LC molecule having the flexible structure for forming an LC layer of the COA type LC panel, in which the LC molecule is shown as a formula (I):

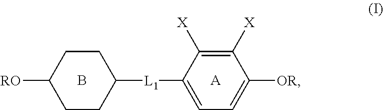

in the formula (I), A represents benzene; B represents cyclohexane; RO— represents an alkoxy group; X represents a fluorine atom; and L1 represents a dimethylene linking group.

In one exemplary embodiment of the present invention, the LC layer further includes liquid crystal reactive monomers (LC RMs) having a formula (IV) below, such that the LC molecule having the formula (I) and the LC RMs having the formula (IV) form an LC composition, and the LC RMs are used to distribute the LC composition onto a polyimide surface of an alignment film:

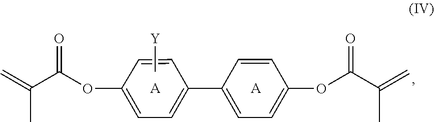

in the formula (IV), A represents benzene; O represents an oxygen atom; and Y represents a hydrogen atom or a fluorine atom, and the LC molecule having the formula (I) has a weight ratio between 5% and 60% based on the total weight of the LC composition, and the remaining is the LC RMs having the formula (IV).

In one exemplary embodiment of the present invention, a cyclohexane C is between a cyclohexane B and an alkoxy group RO— on a straight chain of the LC molecule having the formula (I), and the LC molecule is represented by a formula (V):

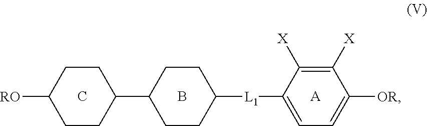

The present invention further provides LC molecule having a flexible structure for forming an LC layer of a COA type LC panel, in which the LC molecule is shown as the following formula (II):

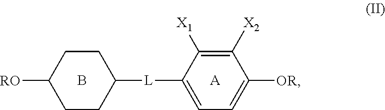

in the formula (II), A represents benzene; B represents cyclohexane; RO— represents an alkoxy group; X1 and X2 are respectively a fluorine atom or a chlorine atom, and at least one of X1 or X2 is a chlorine atom; and L represents a biphenyl linking group.

In one exemplary embodiment of the present invention, the LC layer further includes liquid crystal reactive monomers (LC RMs) having a formula (IV) below, such that the LC molecule having the formula (II) and the LC RMs having the formula (IV) form an LC composition, and the LC RMs are used to distribute the LC composition onto a polyimide surface of an alignment film:

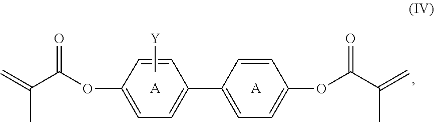

in the formula (IV), A represents benzene; O represents an oxygen atom; and Y represents a hydrogen atom or a fluorine atom, and the LC molecule having the formula (II) has a weight ratio between 5% and 60% based on the total weight of the LC composition, and the remaining is the LC RMs having the formula (IV).

In one exemplary embodiment of the present invention, in which C, which represents cyclohexane, is between B, which represents cyclohexane, and RO—, which represents an alkoxy group, on a straight chain of the LC molecule having the formula (II), and the LC molecule is represented by a formula (VI):

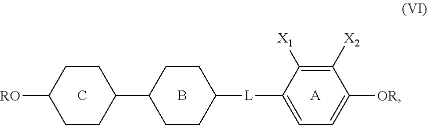

The present invention also provides an LC molecule having a flexible structure for forming an LC layer of a COA type LC panel, in which the LC molecule is shown as the following formula (III):

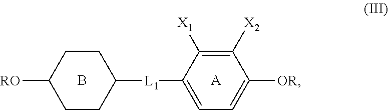

in the formula (III), A represents benzene; B represents cyclohexane; RO— represents an alkoxy group; X1 and X2 are respectively a fluorine atom or a chlorine atom, and at least one of X1 or X2 is a chlorine atom; and L1 represents a dimethylene linking group.

In one exemplary embodiment of the present invention, the LC layer further includes LC RMs having a formula (IV) below, such that the LC molecule having the formula (III) and the LC RMs having a formula (IV) form an LC composition, and the LC RMs are used to distribute the LC composition onto a polyimide surface of an alignment film:

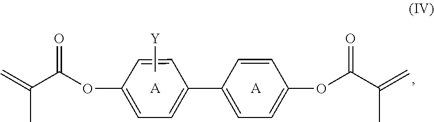

in the formula (IV), A represents benzene; O represents an oxygen atom; and Y represents a hydrogen atom or a fluorine atom, and the LC molecule having the formula (III) has a weight ratio between 5% and 60% based on the total weight of the LC composition, and the remaining is the LC RMs having the formula (IV).

In one exemplary embodiment of the present invention, in which C represents cyclohexane, is between B, which represents cyclohexane, and RO—, which represents an alkoxy group, on a straight chain of the LC molecule having the formula (III), and the LC molecule is represented by a formula (VII):

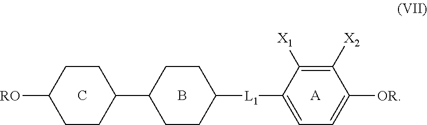

Furthermore, the present invention provides a mixture of LC molecule having a flexible structure for forming an LC layer of a COA type LC panel, and the mixture includes the LC molecule having formulas (I), (II) and (III) above.

The present invention has obvious advantages and beneficial effects than the prior art. The LC molecule having the flexible structure and the mixture of the present invention has at least the following advantages and beneficial effects by the above technical solution. The LC molecule having the flexible structure of the present invention is modified from the traditional LC molecule. The wetting ability of the LC molecule within the COA type LC panel is increased by properties of the flexible structure, so that the LC molecule having the flexible structure obtains better diffusing performance than that of the traditional LC molecule, and thus the problem of drop Mura effect in the COA type LC panel is improved.

### BRIEF DESCRIPTION OF THE DRAWINGS

FIG. 1 is a schematic view of a structure of a color-filter-on-array type LC panel according to one embodiment of the present invention; and

FIG. 2 is a schematic view of a structure of a color-filter-on-array type LC panel according to another embodiment of the present invention.

### DETAILED DESCRIPTION OF THE PREFERRED EMBODIMENTS

Various preferred embodiments are now described with reference to the accompanying drawings. In the following description, for purposes of explanation, numerous specific details are set forth in order to provide a thorough understanding of a liquid crystal molecule having a flexible structure and a mixture thereof, and its specific embodiment, structure, feature and functions.

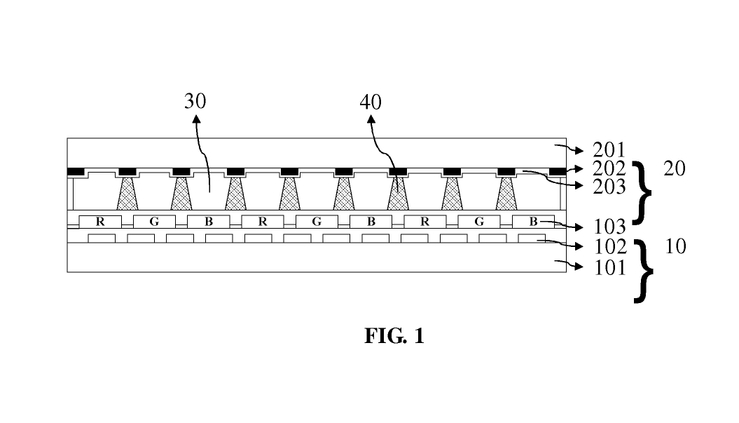

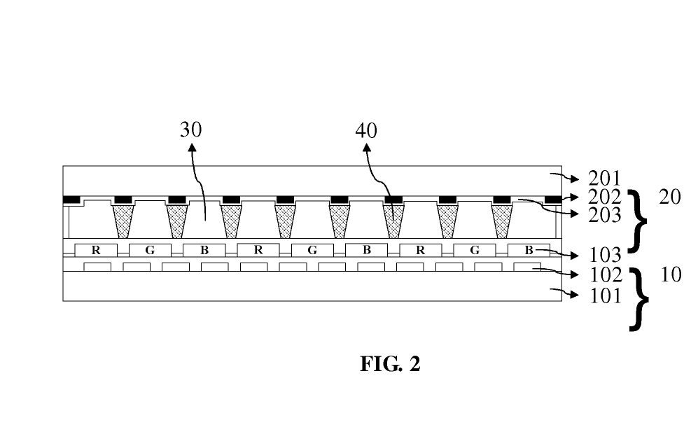

Please refer to FIGS. 1 and 2. FIGS. 1 and 2 are schematic views of a structure of a color-filter-on-array (COA) type a liquid crystal (LC) panel according to two embodiments of the present invention. The COA type LC panel includes a first substrate 10, a second substrate 20, a liquid crystal (LC) layer 30, and a plurality of spacers 40. The first substrate 10 and the second substrate 20 are correspondingly arranged, and the LC layer 30 is sandwiched between the first substrate 10 and the second substrate 20. The first substrate 10 can be a COA type LC substrate, which includes a first transparent substrate 101, a thin film transistor (TFT) array layer 102, and a color filter layer 103. The TFT array layer 102 is disposed on an inner surface of the first transparent substrate 101, and the color filter layer 103 is disposed on the TFT array layer 102. The second substrate 20 is a substrate which is opposite to the first substrate 10. The second substrate 20 includes a second transparent substrate 201, a black matrix layer 202, and a transparent conductive film 203. The black matrix layer 202 is disposed on the inner surface of the second transparent substrate 201, and the transparent conductive film 203 is disposed on the black matrix layer 202. The spacers 40 are disposed on the inner surface of the first substrate 10 in accordance with one embodiment of the present invention, and the spacers 40 are extended from the inner surface of the first substrate 10 to the inner surface of the second substrate 20 (please refer to FIG. 1). The spacers 40 are disposed on the inner surface of the second substrate 20 in accordance with another embodiment of the present invention, and the spacers 40 are extended from the inner surface of the second substrate 20 to the inner surface of the first substrate 10 (please refer to FIG. 2). LC molecules of the LC layer 30 are the LC molecules having a flexible structure.

The LC molecules having the flexible structure of the LC layer 30 of the present invention will now be discussed in further detail. The LC molecules having the flexible structure of the present invention are to employ rod-like LC molecules of the prior art as a modifying object, e.g., refer to formulas (VIII) and (IX) in the above-mentioned background of the invention. The rod-like LC molecules are polymers containing an aromatic ring and an alicyclic ring on a straight chain thereof. The inventors of the present invention have done intensive studies to solve the subject as mentioned in the description of the background, and the rod-like LC molecules are modified by an introduction of a functional linking group and/or a functional side group in a molecular chain of the rod-like LC molecules. In other words, a flexible chain having flexible properties (e.g., a dimethylene linking group) is introduced between a benzene (i.e., labeled “A”) and a cyclohexane (i.e., labeled “B”) on the straight chain of the rod-like LC molecules; and/or a flexible lateral group having flexible properties is introduced onto two lateral groups of a benzene (i.e., labeled “A”) within the rod-like LC molecules, to form the LC molecules having the flexible structure. The two lateral groups can be a fluorine atom or a chlorine atom, and at least one of the two lateral groups is a chlorine atom. If the LC molecules having a formula (VIII) are employed as the modifying object, and the modification can have three possibilities (as shown in formulas (I), (II) and (III)). Thus, the flexible structure of the flexible chain and the flexible lateral group also has properties of the flexible structure on the molecular chain of the LC molecules having the flexible structure. The LC molecule having the flexible structure according to a formula (I), (II) or (III) is filled in the COA type LC substrate, and as the LC layer 30 thereof. The wetting ability of the LC molecule within the COA type LC panel is increased by properties of the flexible structure, so that the LC molecule having the flexible structure obtains better diffusing performance than the rod-like LC molecule. Thus, the problem of drop Mura effect in the COA type LC panel can be improved.

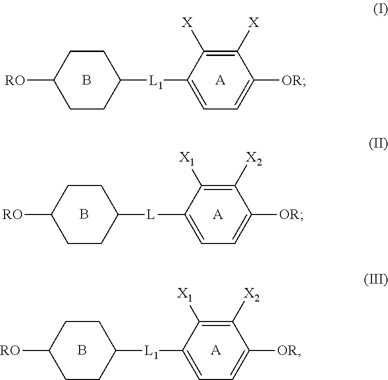

in the formulas (I), (II) and (III), A represents benzene; B represents cyclohexane; RO— represents an alkoxy group; X represents a fluorine atom; X1 and X2 are respectively a fluorine atom or a chlorine atom, and at least one of X1 or X2 is a chlorine atom; L represents a biphenyl linking group; and L1 represents a dimethylene linking group, in which L1 is a flexible chain, and X1 and X2 are a flexible lateral group.

In addition to the LC molecules having the flexible structure, the LC layer 30 of the present invention further includes liquid crystal reactive monomers (LC RMs) having a formula (IV) below. The LC RMs having the formula (IV) and the LC molecules having the formula (I), (II) or (III) form an LC composition. The LC RMs are used to distribute the LC composition onto a polyimide surface of an alignment film. The LC composition includes the LC molecules having the flexible structure and the LC RMs having the formula (IV), the LC RMs having the formula (IV) are shown as following:

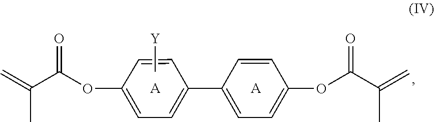

in the formula (IV), A represents benzene; O represents an oxygen atom; and Y represents a hydrogen atom or a fluorine atom, and the LC molecules having the formula (I), (II) or (III) has a weight ratio between 5% and 60% based on the total weight of the LC composition, and the remaining is the LC RMs having the formula (IV).

It should be noted that the formulas (I), (II) and (III) are to employ the formula (VIII) as a modifying object. However, the rod-like LC molecules further includes another form, that is, a formula (IX). The difference between the LC molecules having the formula (IX) and the LC molecules having the formula (VIII) is that C, which represents cyclohexane, is between B, which represents cyclohexane, and RO—, which represents an alkoxy group, on a straight chain of the LC molecules having the formula (IX). If the LC molecules having the formula (IX) are employed as the modifying object, and that can also have three possibilities (as shown in formulas (V), (VI) and (VII)) after modification.

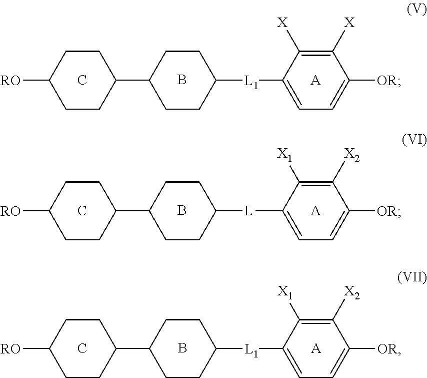

in the formulas (V), (VI) and (VII), A represents benzene; B and C are cyclohexane; RO— represents an alkoxy group; X represents a fluorine atom; X1 and X2 are respectively a fluorine atom or a chlorine atom, and at least one of X1 or X2 is a chlorine atom; L represents a biphenyl linking group; and L1 represents a dimethylene linking group, in which L1 is a flexible chain, and X1 and X2 are a flexible lateral group.

According to the LC molecules in the LC layer 30, the LC molecules having a formula (I), (II), (III), (V), (VI), (VII), (VIII) or (IX) can be freely mixed to be used as LC materials within the LC layer 30 in accordance with requirements of an user. The LC materials can be a mixture of the LC molecules having formulas (I-1), (VI-1) and (VII-1).

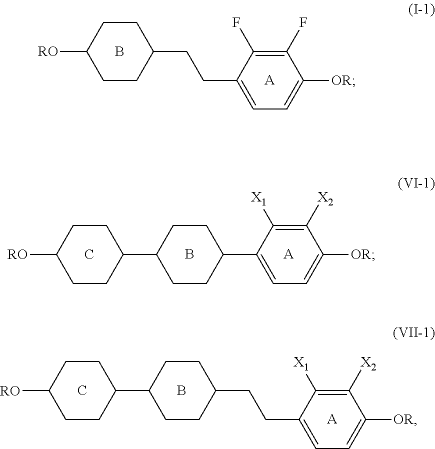

in the formulas (I-1), (VI-1) and (VII-1), A represents benzene; B and C are cyclohexane; RO— represents an alkoxy group; F represents a fluorine atom; and X1 and X2 are respectively a fluorine atom or a chlorine atom, and at least one of X1 or X2 is a chlorine atom.

As above-mentioned, the LC molecule having the flexible structure of the present invention is the flexible structure which is introduced into an LC molecule through modification, so that the LC molecule has properties of the flexible structure. Thereby, the wetting ability of the LC molecule within the COA type LC panel is increased to affect diffusing ability thereof, and thus the problem of drop Mum effect of the COA type LC panel can be improved.

The above description of the invention is intended to be illustrative and not limiting. Various changes or modifications in the embodiments described may occur to those skilled in the art. These can be achieved without departing from the spirit or scope of the invention.

What is claimed is:

1. A mixture of liquid crystal (LC) molecules having a flexible structure, for forming an LC layer of a color-filter-on-array (COA) type LC panel, wherein the mixture comprises the LC molecules having the following formulas (I), (II) and (III): 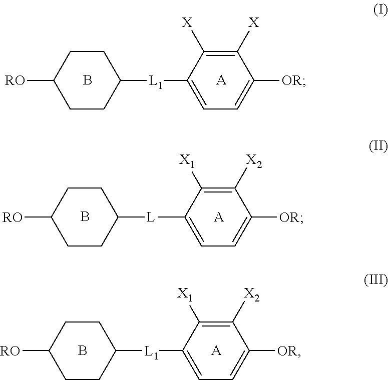
wherein A represents benzene; B represents cyclohexane; RO— represents an alkoxy group; X represents a fluorine atom; X1 and X2 are respectively a fluorine atom or a chlorine atom, and at least one of X1 or X2 is a chlorine atom; L represents a biphenyl linking group; and L1 represents a dimethylene linking group.

2. The mixture of LC molecules having the flexible structure according to claim 1, wherein the LC layer further comprises liquid crystal reactive monomers (LC RMs) having a formula (IV) below, the mixture of the LC molecules having the formulas (I), (II) and (III) and the LC RMs having the formula (IV) form an LC composition, and the LC RMs distribute the LC composition onto a polyimide surface of an alignment film: 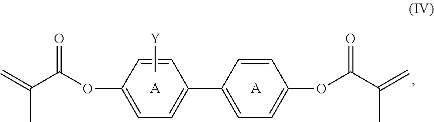
wherein A represents benzene; O represents an oxygen atom; and Y represents a hydrogen atom or a fluorine atom, wherein the mixture of the LC molecules having the formulas (I), (II) and (III) has a weight ratio between 5% and 60% based on the total weight of the LC composition, and the remaining is the LC RMs having the formula (IV).

3. The mixture of LC molecules having the flexible structure according to claim 1, wherein a cyclohexane C is linked between cyclohexane B and alkoxy group RO— on a straight chain of the LC molecule having the formula (I), and the LC molecule is further represented by a formula (V):

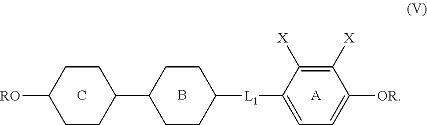

4. The mixture of LC molecules having the flexible structure according to claim 1, wherein a cyclohexane C is linked between cyclohexane B and alkoxy group RO— on a straight chain of the LC molecule having the formula (II), and the LC molecule is further represented by a formula (VI):

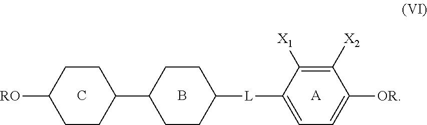

5. The mixture of the LC molecules having the flexible structure according to claim 1, wherein a cyclohexane C is linked between cyclohexane B and alkoxy group RO— on a straight chain of the LC molecule having the formula (III), and the LC molecule is further represented by a formula (VII):

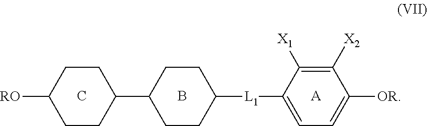

6. An Liquid crystal (LC) molecule having a flexible structure, for forming an LC layer of a color-filter-on-array (COA) type LC panel, wherein the LC molecule is shown as a formula (I): 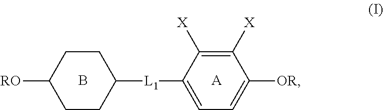
wherein A represents benzene; B represents cyclohexane; RO— represents an alkoxy group; X represents a fluorine atom; and L1 represents a dimethylene linking group.

7. The LC molecule having the flexible structure according to claim 6, wherein the LC layer further comprises liquid crystal reactive monomers (LC RMs) having a formula (IV) below, the LC molecule having the formula (I) and the LC RMs having the formula (IV) form an LC composition, and the LC RMs distribute the LC composition onto a polyimide surface of an alignment film: 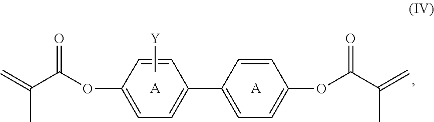
wherein A represents benzene; O represents an oxygen atom; and Y represents a hydrogen atom or a fluorine atom, wherein the LC molecule having the formula (I) has a weight ratio between 5% and 60% based on the total weight of the LC composition, and the remaining is the LC RMs having the formula (IV).

8. The LC molecule having the flexible structure according to claim 6, wherein a cyclohexane C is linked between cyclohexane B and alkoxy group RO— on a straight chain of the LC molecule having the formula (I), and the LC molecule is further represented by a formula (V):

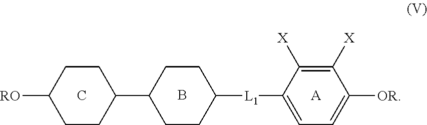

9. An LC molecule having a flexible structure, for forming an LC layer of a color-filter-on-array (COA) type LC panel, wherein the LC molecule is shown as a formula (II): 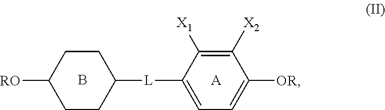
wherein A represents benzene; B represents cyclohexane; RO— represents an alkoxy group; X1 and X2 are respectively a fluorine atom or a chlorine atom, and at least one of X1 or X2 is a chlorine atom; and L represents a biphenyl linking group.

10. The LC molecule having the flexible structure according to claim 9, wherein the LC layer further comprises liquid crystal reactive monomers (LC RMs) having a formula (IV) below, the LC molecule having the formula (II) and the LC RMs having the formula (IV) form an LC composition, and the LC RMs distribute the LC composition onto a polyimide surface of an alignment film: 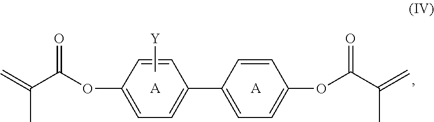
wherein A represents benzene; O represents an oxygen atom; and Y represents a hydrogen atom or a fluorine atom, wherein the LC molecule having the formula (II) has a weight ratio between 5% and 60% based on the total weight of the LC composition, and the remaining is the LC RMs having the formula (IV).

11. The LC molecule having the flexible structure according to claim 9, wherein a cyclohexane C is linked between cyclohexane B and alkoxy group RO— on a straight chain of the LC molecule having the formula (II), and the LC molecule is represented by a formula (VI):

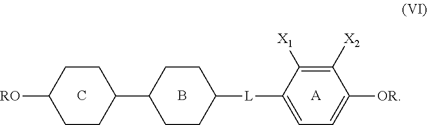

12. An LC molecule having a flexible structure, for forming a LC layer of a color-filter-on-array (COA) type LC panel, wherein the LC molecule is shown as a formula (III): 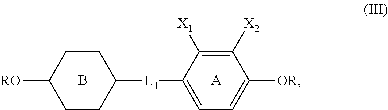
wherein A represents benzene; B represents cyclohexane; RO— represents an alkoxy group; X1 and X2 are respectively a fluorine atom or a chlorine atom, and at least one of X1 or X2 is a chlorine atom; and L1 represents a dimethylene linking group.

13. The LC molecule having the flexible structure according to claim 12, wherein the LC layer further comprises liquid crystal reactive monomers (LC RMs) having a formula (IV) below, the LC molecule having the formula (III) and the LC RMs having the formula (IV) form an LC composition, and the LC RMs distribute the LC composition onto a polyimide surface of an alignment film: 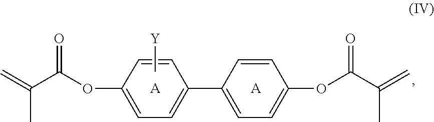
wherein A represents benzene; O represents an oxygen atom; and Y represents a hydrogen atom or a fluorine atom, wherein the LC molecule having the formula (III) has a weight ratio between 5% and 60% based on the total weight of the LC composition, and the remaining is the LC RMs having the formula (IV).

14. The LC molecule having the flexible structure according to claim 12, wherein a C cyclohexane is linked between cyclohexane B and alkoxy group RO— on a straight chain of the LC molecule having the formula (III), and the LC molecule is represented by a formula (VII):

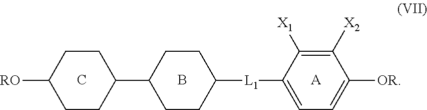

15. The LC molecule having the flexible structure according to claim 12, further comprising an LC molecule having the formula (I) of claim 6 and an LC molecule having the formula (II) of claim 9.
